(19) United States
(12) Patent Application Publication
(10) Pub. No.: US 2004/0055797 A1
(43) Pub. Date: Mar. 25, 2004

(54) Electromagnetic, ''fuelless,'' passenger vehicle (automobile)

(76) Inventor: Chester White, Corona, NY (US)

Correspondence Address: Chester White, P.O. Box 647, Corona, NY, 11368, US

(21) Appl. No.: 10/668,870

(22) Filed: Sep. 22, 2003

Related U.S. Application Data
(63) Continuation-in-part of application No. 10/079,471, filed on Feb. 19, 2002, now abandoned.

(51) Int. Cl. B60K 1/00

(52) U.S. Cl. 180/65.1

(57) ABSTRACT

This invention would be the first passenger automobile not requiring gas or any other fuel of any kind; nor will it require either solar or electric energy. The vehicle will operate, (will be powered) by the dynamics of the physical effects of electromagnetism and centrifugal forces arising from the momentum of two independently spinning steel discs, facing each other horizontally, and moving in alternate, (clockwise and counterclockwise) directions. These are the Drive Discs. Between these two discs are two rotating Drive Shafts which are connected to, both, the front and rear wheel gear hubs. Sustained “spin” is achieved by the natural repulsive forces of two opposing magnets having the same polarity. All variations in speed, etc. are computer controlled for the essential power train torque rotation and locomotion of the vehicle. This concept drastically alters the perception of the automobile with its internal combustion engine, need for a radiator, muffler, anti-freezer etc. In fact, this vehicle does not have what is usually thought of as an “engine.” That is, the more powerful the electromagnetic force, the higher the horsepower. Moreover, the novel idea addresses both air pollution and global oil depletion concerns.

### BACKGROUND

1. Field of Invention

This invention relates to the field of automobile technology and natural resources conservation. More specifically, to a passenger auto vehicle that does not require liquid or combustible fuel of any kind for its operation, nor does it require solar energy or the time-consuming batteries which require regular recharging.

2. Description of Prior Art

It is known that many attempts have been made to invent an automobile which utilizes the least amount of liquid fuel for operation of the vehicle. Success of the creation of any such vehicle would require unmitigated performance and mileage objectives. The present invention does not use fossil fuel. On the contrary, it operates on principles of physics involving electromagnetism. Together with the physical dynamics of centrifuge, momentum, and torque, the idea for this passenger vehicle supersedes all others in that it addresses vital environmental circumstances which are regularly emphasized in regards to automobile emissions, in addition to the ongoing dependence on foreign oil production and concerns for its projected global depletion. There appears not to exist an automobile of record which addresses the dilemma, stated above, as does the present invention of an electromagnetic motor vehicle.

### OBJECTS AND ADVANTAGES

The valued alternative to the obvious deleterious factors involved with cost and negative environmental concerns involved with implementation of all other innovations proposed to date, the present vehicle proposes highly desirable, “quality-of life,” (and health) issues. These are:

a. to provide a passenger vehicle which will address the ongoing concerns that society, at large, has for the quality of the air. Cars that do not spew any automobile exhaust emissions into the air will constitute an immense factor in the preservation of health, particularly those affected with adverse or compromised respiratory conditions.

b. to provide a passenger vehicle which will use no gasoline or any other fossil fuel. Such elimination of liquid fuel usage constitutes a reshaping of, even, political relations among oil-producing countries and the United States.

c. to provide a passenger vehicle which will allow the consumer to conserve an immense amount of money now being spent on gasoline.

d. to provide a passenger vehicle which will allow a more trouble-free automobile which will not have the usual motor and engine breakdown and repair required by the contemporary automobile. There will not be the friction and heat buildup as is common with the internal combustion engine.

### SUMMARY

The present invention will operate, (will be powered) by the dynamics of the physical laws of electromagnetism. Centrifugal and momentum forces arising from the clockwise and counterclockwise spin of two metallic discs whose peripheral rims are magnetized with the same polarity as four facing stationary electromagnets thus making the rims, (Drive Discs) to spin, causing the movement of the vehicle. Such vehicle, requiring no fuel at all, will accrue to the user, and to the environment, an item that will be user friendly, economical, and good for everyone's health.

### BRIEF DESCRIPTION OF THE DRAWINGS

FIG. 1 shows the top perspective view of some of the components of assembly of the system. The upper Drive Disc 16 is shown as to how it is positioned into the chassis of an automobile. An onboard computer is functional as to the necessary changes of the vehicle with respect to speed, braking power, acceleration, miles per hour tracking, gear changes, and other necessary functions of an automobile of this nature. It is contiguous to all control systems, including the hydraulic system for movement drive shafts, Expansion Ring Gears, and engagement of electromagnet to the Drive Discs.

FIG. 2 shows the side view of the apparatus and how it is situated on the underside of an automobile vehicle. From a distance, one could partially see the bottom portion of the system beneath the vehicle.

FIG. 3 shows one of two identical “Drive Discs” both of whose right-angle edges are magnetized. The grooved surfaces of these two discs would face each other and be stacked laterally. Shown here are the concentric circles of grooved sections or “tiers” through which two opposing gear components would, both, move out from their centers on these discs toward peripheries and back from peripheries towards the centers—as the two discs spin: one in clockwise direction, the other counterclockwise.

FIG. 4A shows the Expansion Ring Gear in position for torque power in turning an interposed drive shaft at its center. It also shows the proximity of the upper and lower Drive Discs 42 and 44. Its Engagement Prongs, with relaxed prong springs, are at the very tip of Drive Shaft as it makes its entry to center for expansion.

FIG. 4B shows the Expansion Ring Gear in position for torque power in turning an interposed drive shaft at its center. This further entry, (subsequent process to 4A) of “tapered” Drive Shaft 52 causes the prong springs 54 to be compressed.

FIG. 5 shows a partial longitudinal perspective of the driving pattern of the rear drive shaft of the system. The Expansion Ring Gears show a silhouette transition of Expansion Ring Gear from lowest speed position 64A to highest speed 64B along a tapered section of Drive Shaft 62.

FIG. 6 shows the system in the “Drive” mode. Both Expansion Ring Gears components are in-gear; both Drive Discs are turning in opposite directions; and expansion ring prongs of both Expansion Ring Gears are in the four grooves of each drive shaft, front and rear—providing torque power causing the vehicle to move.

FIG. 7 shows the system in the “Reverse” direction mode. The front drive shaft is disengaged; the rear drive shaft juts forward to engage the Expansion Ring Gear of the opposite side 78. Its own Expansion Ring Gear 76B is disengaged. Accordingly, the rear drive shaft will turn in the opposite direction.

FIG. 8 shows the system in “Neutral” mode. There is neither gears nor grooves. The teeth of both Expansion Ring Gears are in the non-grooved, non-drive, area as indicated in FIGS. 3-38.

FIG. 9 This is a top view showing how several of the interrelated components are situated and how they, independently, move.

FIG. 10 This figure is the rear section of the chassis of an automobile. It reveals the capability of the Drive Shaft 94 to slightly move forward to accommodate reverse movement of vehicle.

### REFERENCE NUMERALS IN DRAWINGS

4 Front Gear Box

6 Rear Gear Box

8 Rear Drive Shaft Insulator

10 Front Drive Shaft Insulator

12 Foot Controls: brake and accelerator

14 Electromagnets

15 Computer

16 Upper Drive Disc

18 Upper Drive Disc: side view

20 Lower Drive Disc: side view

22 Front Expansion Ring Gear

24 Rear Expansion Ring Gear

26A Lower Electromagnet Set

26B Upper Electromagnet Set

28 Drive Disc Housing: contains Drive Disc assembly

30 Front Drive Shaft

32 Rear Drive Shaft

34 Grooves for Expansion Ring Gear Teeth

35 Sequential Grooves for Groove-Track Segments

36 Central Support Shaft: supports upper and lower Drive Discs

38 Non-grooved segment of disc: no contact between gears

40 Magnetized periphery of Drive Disc

42 Cut-away section of upper Drive Disc

43A Gear Receptacles for lower Drive Disc

43B Gear Receptacles for upper Drive Disc

44 Cut-away section of lower Drive Disc

46A Engagement Prongs

46B Engagement Prong Spring

48 Gear Teeth of Expansion Ring Gear

50 Engaged Prong of Expansion Ring Gear

52 Frontal View of tapered expanding Drive Shaft entering center of Expansion Ring Gear

53 connection adapter for attaching/detaching wire connection unit

54 Prong Spring: compressed due to expanding center

56 Central Support Shaft: supports upper and lower Drive Discs

57 Ball-bearing sleeve for rear drive shaft

58 Front Drive Shaft Groove: for prongs of Expansion Ring Prongs

60 Front Drive Shaft

62 Rear Drive Shaft

64A Shows potential positions for Rear Drive Shaft 66 for “Drive.”

64B Shows potential positions for Rear Drive Shaft 66 for “Drive.”

66 Rear Drive Shaft

68A Upper Electromagnet

68B Lower Electromagnet

70A Forward, non-grooved, tip of Front Drive Shaft

70B Forward, non-grooved, tip of Rear Drive Shaft

72A Position for forward “Drive” of Front Expansion Ring Gear

72B Position for forward “Drive” of Rear Expansion Ring Gear

74A Upper Drive Disc (side view)

74B Lower Drive Disc (side view)

76A Position for “Reverse Drive” of Front Expansion Ring Gear

76B Position for “Reverse Drive” of Rear Expansion Ring Gear

78 “Engaged” Drive Shaft tip of REAR Drive Shaft

80 Rear Drive Shaft Groove: for prongs of Expansion Ring

82A Position for “Neutral Gear” of Front Expansion Ring Gear

82B Position for “Neutral Gear” of Rear Expansion Ring Gear

83 Shows non-engagement of Grooves of front and rear drive shafts by Ring Gears

84 Partial Perspective, top—transparency—view of Drive Disc Assembly Scheme

86A Hydraulic Gear Controller

86B Hydraulic Drive Shaft Controller

86C Expansion Ring Gear Clasp

86D Hydraulic Drive Shaft Control Arm

86E Hydraulic Expansion Ring Gear Control Arm

87 Front Expansion Ring Gear

88A Front Drive Shaft Section

88B Rear Drive Shaft Section

90 Drive Shaft Gear Gear Actuator

92 Rear Gear Box

94 Extended Drive Shaft

95 Rear Drive Shaft Insulator

### DESCRIPTION—ADDITIONAL EMBODIMENT

Additional embodiments would entail application to such conveyance vehicles as watercraft, commercial, and non-commercial trucks, buses, power generators, and aircraft. According to features of present invention, adaptations are realizable essentially relevant to the singular dynamics of the rotary, dual-disc, mechanism which can propel a vehicle.

### DETAILED DESCRIPTION

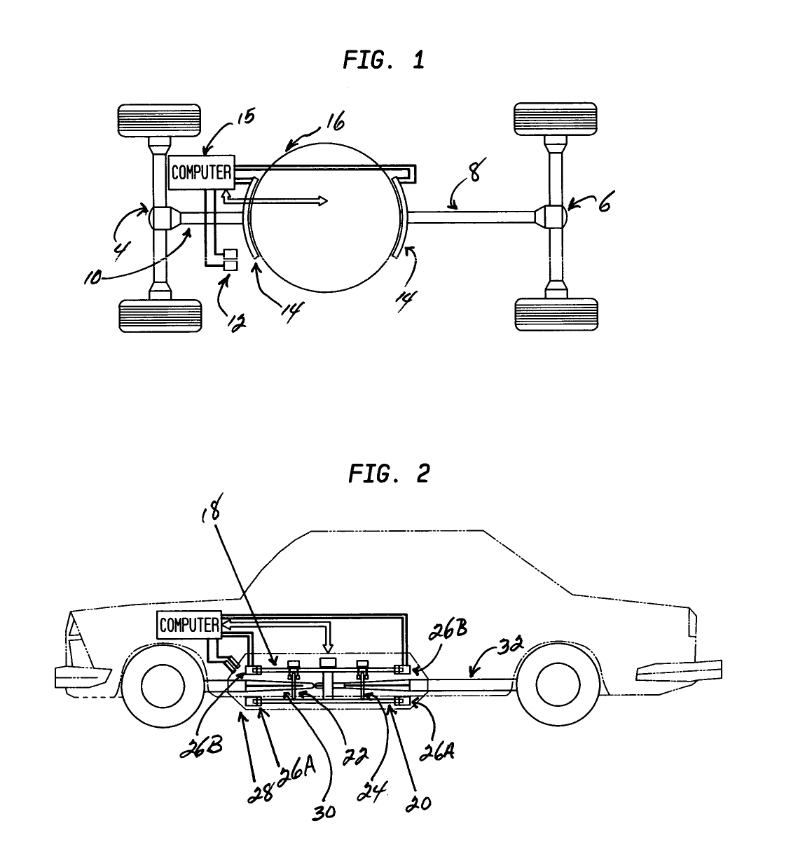

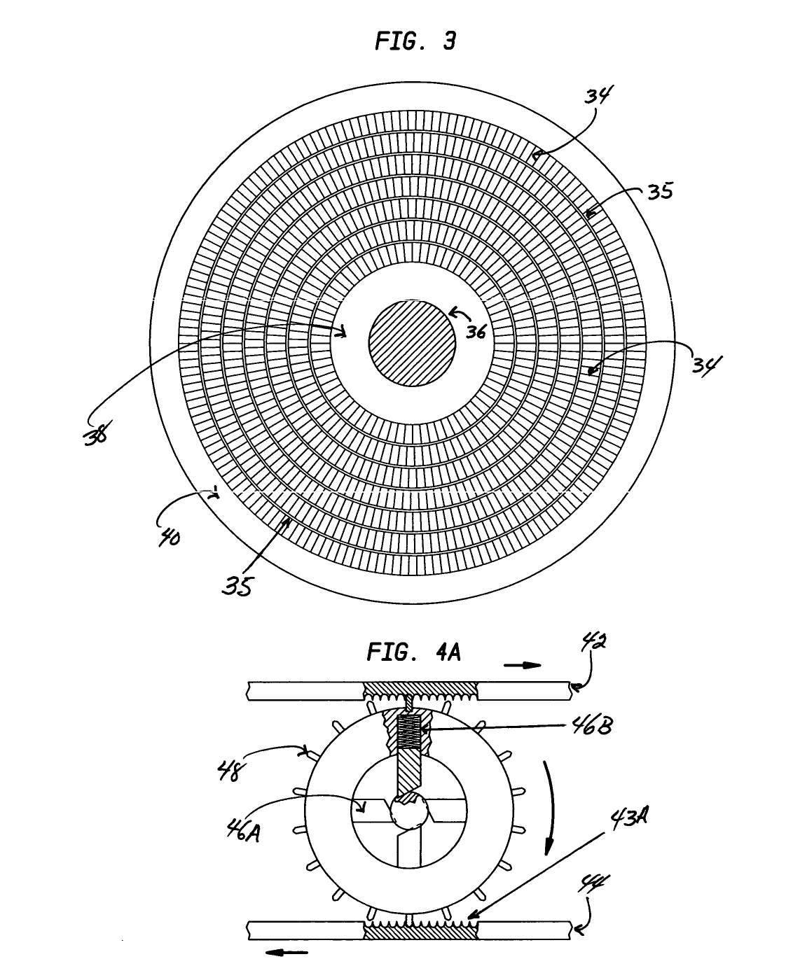

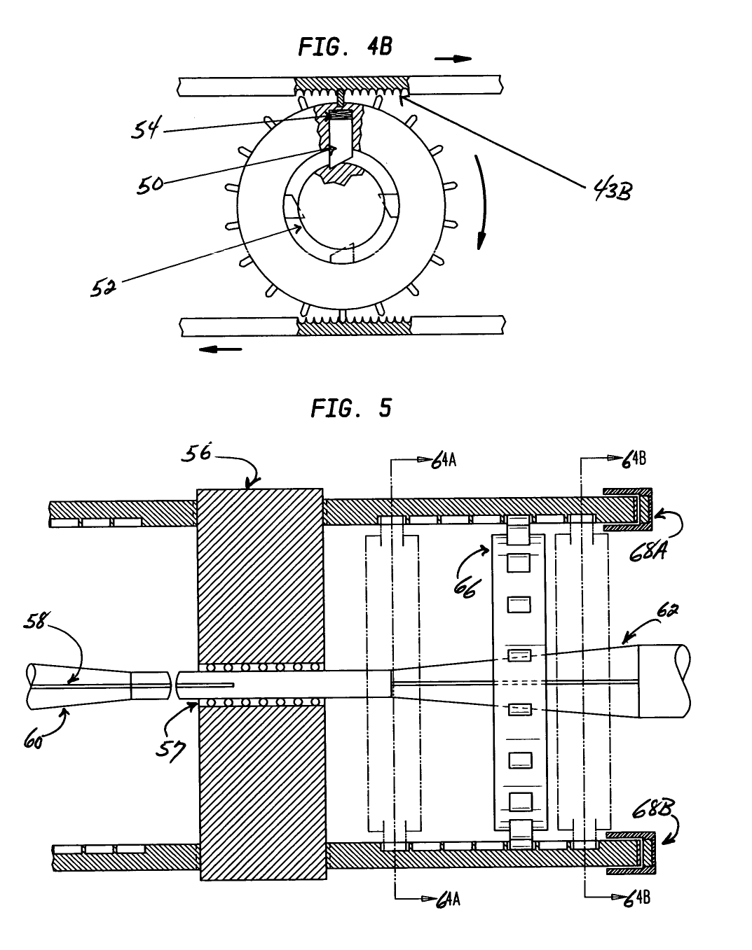

The following entails a concept which, once reduced to practical usage, would be the first passenger automobile not requiring gas or any other fuel of any kind; nor will it require either solar or electric energy. The vehicle will operate, (will be powered) by the dynamics of the physical effects of electromagnetism and both centrifugal and centripetal forces arising from the momentum of two independently spinning steel discs FIG. 3 facing each other, laterally, and moving in alternate, (clockwise and counterclockwise) directions. These are the Drive Discs. Between these two discs are two rotating Drive Shafts FIG. 2:30,32, FIG. 5:60, 62. that are connected to the front and rear wheel gear hubs FIG. 1:4, 6. These provide the essential power train torque rotation and locomotion of the vehicle. This concept drastically alters the perception of the automobile with its internal combustion engine, need for a radiator, muffler, anti-freeze, etc. In fact, this vehicle does not have what is usually thought of as an “engine.” Nevertheless, it is empowered with as much as, or exceeding, the “horsepower” of the automobiles now prevalent. That is, the more powerful the electromagnetic force, the higher the horsepower. It can attain the same mph speeds, save immensely on the expense of gas, (negating it altogether) oil, etc. Additionally, as opposed to other “electric” cars, this one, though requiring a battery to enable electromagnetic current, will not need battery recharging every 50 or so miles. Such recharging could require up to 3 hours for such other cars. It is presumed this, presently-introduced, innovative automobile will have a self-charging battery arising from the potential “generator” operation of the disks.

For this automobile, there is no engine noise or vibration; there are neither radiator nor coolant-antifreeze considerations since there's neither engine heat buildup nor adverse effect due to low temperatures. Lubrication is necessary only for those respective gears and bearings requiring it.

How it Works I (Electromagnetism):

The automobile will be powered by a combination of two sets of electromagnets FIG. 1:14, FIG. 2:26A, 26B, FIG. 5:68 (four in all) and the above-mentioned disc pair. The electromagnetic sets are at opposite proximities of, and facing, the peripheral rims of upper and lower, horizontally placed, spinning discs; see FIGS. 5:68A, 5:68B. The circumferences, (outer edges, rims) of these two discs will be magnetized. That is, there will be 360 degrees of magnetized rim surfaces of the two discs; see FIG. 3:40. The magnetic rims will have the “same” charge in polarity of upper and lower electromagnet sets. Due to the natural repulsive effect of these sets of facing magnets, the resultant force of movement, (away from—and to the right, (or left)) constitutes the spin of the two discs in opposite directions from the stationary magnet sets. Using the physical laws of centrifuge, momentum, and the “repulsive force” of the electromagnets, constitutes the driving force of this novel idea. Two connecting specially-designed Drive Shafts are to be interposed between the two discs at opposite ends proceeding from the discs' centers projecting outwards towards front and rear gear hubs. Visually, the appearance is likened to a disc-shaped, double-decker, lollipop with two opposing, rotating, stems, Drive Shafts.

How it Works II (Rotary Disk System):

The facing disk surfaces of the heavy-duty metallic discs will measure the width of the automobile. The mass of the two independently-suspended discs would be of such weight, along with their spinning momentum, to dynamically interact effectuating the torque movement of connected drive shafts bringing about locomotion of a motor vehicle. The concentric circles, (rings) are calibrated for 120 mph at one ring per 10 ten miles, (from interior radius to exterior radius of Drive Disk) with each ring covering a ten-speed gradation/tier. At the top of each gradation, during acceleration, Drive Disc will increase in rpm's, (as gear teeth remain in their groove) toward the next higher 10-speed gradation/tier speed, or groove. Disk rpm, as well as gear placement and accelerator system, are controlled by an onboard computer. The computer effectuates hydraulic dynamics to, both, the independent Drive Shafts as well as the Expansion Ring Gears.

Dynamic Design provides for both front as well as rear wheel drive. Thus, with depression of accelerator, both anterior and rear drive shafts' Expansion Ring Gears will transit from their centers outward toward their peripheries—see FIG. 6—with an accompanying increase in velocity of Drive Discs providing accelerated speed of turn of Drive Shafts and consequent speed of automobile. The computer will “position” the hydraulically effected Drive Shafts to the specified, calibrated, mph location in the facing Drive Disc tier—all conforming to the mph speed desired by operator. From the position of standstill, gear teeth are at a location near center of drive discs. At lowest speeds, gear teeth are set at first track, or “tier,” from center FIG. 3:38 groove radiating from center of Drive Discs FIG. 3. Due to position of Expansion Ring Gears being near center of Drive Discs, torque effect is greatest; momentum effect is least. Upon the operator's depression of accelerator pedal, the electromagnets FIG. 1:14, FIG. 2:26A, 26B, and FIG. 5:68 held on movable arm, come closer making the disks to revolve faster and Drive Shafts to increase in torque, increasing acceleration. As rpm's reach designated speed tier and higher speed is desired, Expansion Ring Gear teeth transit to next higher tier moving “outward,” (in direction of periphery) to the next higher “speed-groove.” The speed mechanism specifies: “the larger the arc the higher the speed”—since the gear teeth ring has to traverse a greater distance with the spin of one singular turn, (rpm) of Drive Discs. Coupled with this aspect of speed is the integrated speed mechanism of the computer-controlled rpm's of the discs themselves, as effected by operator on accelerator.

Gears I: At Expansion Ring Gears FIGS. 4A, 4B, there are “teeth” which fit into grooves designed into the facing sides of two laterally-facing Drive Discs, one atop the other FIG. 6:74A, 74B. The concentric grooves of each disc are each calibrated with an individual receptacle designed to fit each of the teeth on the Drive Shaft head. This fit, (or mesh) between teeth and groove constitutes the gear assembly which effectuates simultaneous torque of drive shafts of both front and rear wheels for locomotion of vehicle. Catch mechanisms are designed into both upper and lower Drive Discs, (one at each ½ turn of Expansion Ring Gears) to “guide” gear teeth along each tier of grooves into the groove receptacles for seamless meshing. This assures there is no “mis-mesh” of the gear teeth into the Drive Discs. This will simultaneously bring all teeth on Expansion Ring Gears in line for continued locomotion of vehicle.

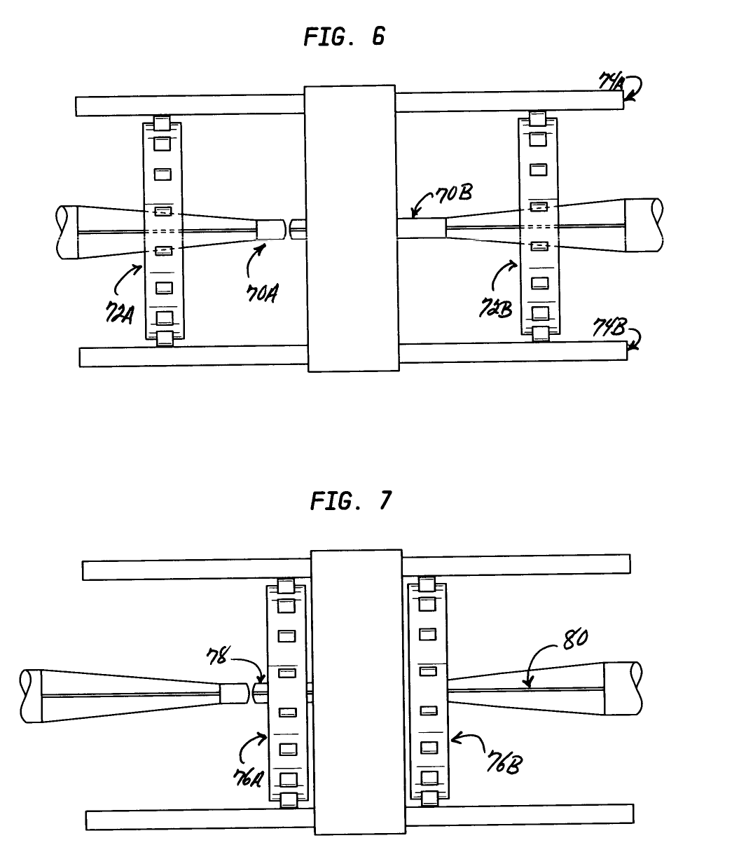

Gears II (Reverse Drive): See FIG. 7. The front Expansion Ring Gear 76:A has passed over to the rear Drive Shaft. It is engaged into the grooved front section of rear Drive Shaft 80 which projected forward fro this purpose. There will be no torque or turning power by the rear Drive Shaft since the Expansion Ring Gear is, in “Reverse,” not in gear. In essence, only one Expansion Ring Gear will be providing torque for reverse, the front Expansion Ring Gear. That is, its engagement into its own grooves in Drive Disc on its own, opposite, side of Drive platform, (but NOT connecting with its own front Drive Shaft) provides the torque energy in “opposite” direction for rear Drive Shaft and thus Reverse.

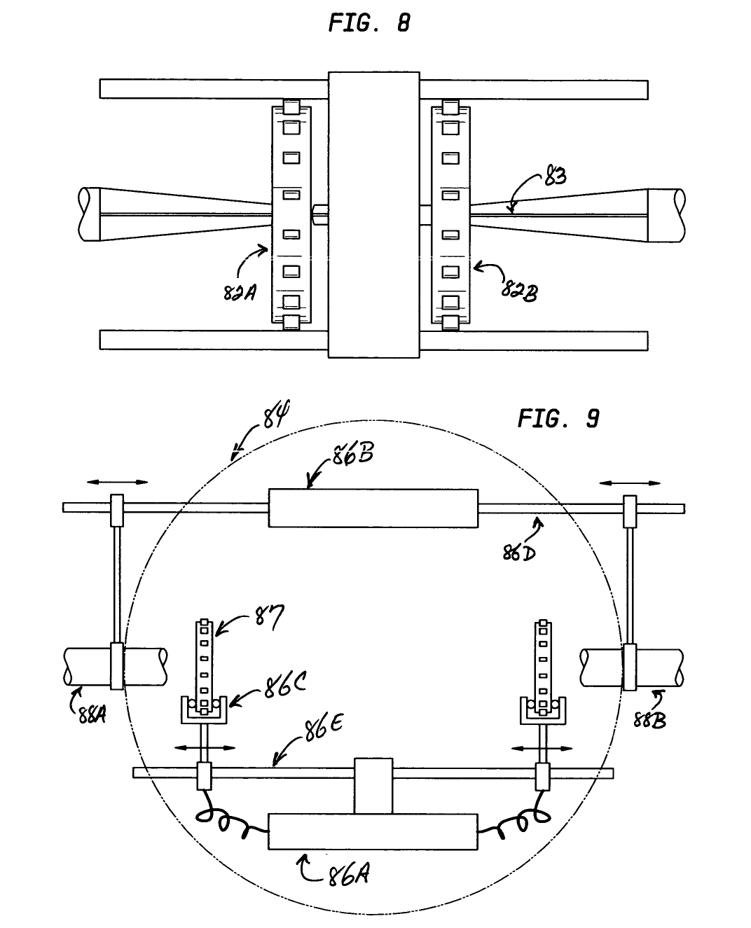

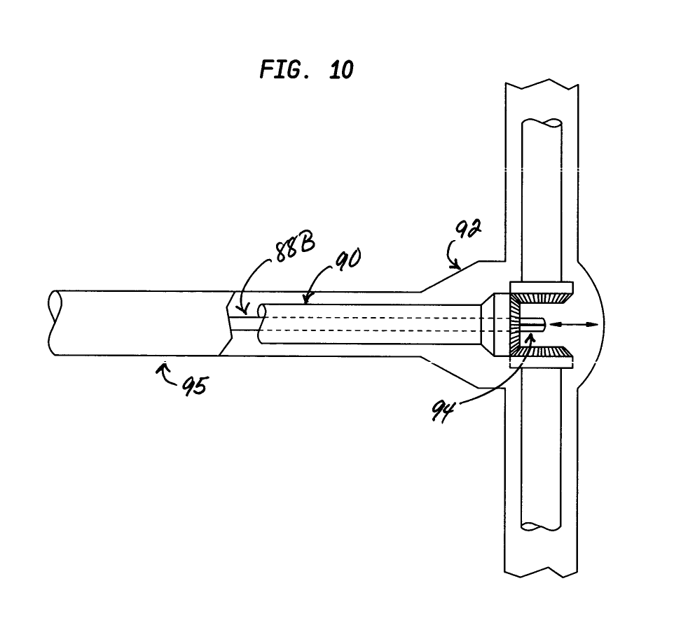

Gears III: The various concentric gradations from inner circumference, (lowest speed) moving toward periphery of Drive Disc, (highest gear, highest speed gradation) constitute the “automatic” (transmission) gear system of this vehicle. The gearshift lever is put into “drive” by operator of vehicle then the operator's accelerator operation determines various positions of the Drive Shaft and speed of automobile. Between the two, (upper and lower) drive discs FIG. 2:18 2:20 there will be two Drive Shafts FIG. 2:30, 32 with gear teeth designed and positioned to mesh with the facing grooved sides of drive discs FIGS. 4A, 4B wherein are the gear grooves FIGS. 4A-43A, 4B-43B into which gear teeth FIGS. 4A-48 are to fit into receptacles along the circular grooves. The rotation of the discs, once electrical current is turned on and shift lever is put into “drive,” will cause rotary movement of anterior, (and posterior) Drive Shafts to their corresponding gear assemblages and movement of automobile, unless brake pedal is depressed.

Location: The system, as described above, would be self-contained and encased in a protective unit positioned anterior to, and somewhat medially, (mid-frame) between front and rear axels of the vehicle FIG. 2:28.

“Ignition” Actually, there's no “ignition” since there are no piston-combustion dynamics as in the typical automobile engine. Once the electrical current is turned on, and the manual gear shift lever is put into “drive” by the vehicle operator, there will be a slow movement of the Drive Disks: the magnets of same polarity will repulse, making the two disks to revolve in opposite directions. This, in turn, causes the connected, specially designed, drive shafts FIG. 2:30, 2:32 to rotate with the consequent locomotion of vehicle, providing the brake pedal is not depressed.

Safety Concerns:

Braking (emergency) at high speed. There has to be immediate disengagement of gears, once brake is applied. When accelerator is released “and” brake pedal is applied, such sequence indicates, to the onboard computer, an emergency situation. Otherwise, (without braking, for 5 seconds) accelerator release, alone, would allow the vehicle to automatically decrease speed mph-by-mph, to lowest-gear drive/movement. However, if operator, at 50 mph, releases accelerator then depresses brake for whatever reason, other than one of an emergency, and the operator's intent is to maintain 50 mph, again, at acceleration, the computer will signal the retraction of the drive gear teeth, but maintain 50 mph position of Drive Shafts, (once accelerator is again repressed—within five seconds). This allows continuance of precisely the same speed. If accelerator is not, again, applied within five seconds, the mechanism will be auto-downshift to lowest speed.

Note: If brake peddle is depressed, again while at 50 mph, and is held as speed decreases, Drive Shafts will adjust to mph speed as determined by speedometer-tachometer/rpm and translated by computer which, in turn, adjusts (simultaneously) through hydraulic system the Drive Shaft position. Thus, with this scenario, speed is not adversely downshifted giving the vehicle a potentially dangerous “jolt.” The rule (mechanical execution) will be (programmed) to have the Drive Shafts to follow the speedometer's reading for split-second pinpoint placement of Drive Shafts heads. Accordingly, if operator applies brake long enough for mph to decrease from 50 to 30, at which speed operator releases brake, speed will readily commence at 30 mph. Again, if brake is held long enough, Drive Shafts will thrust forward to neutral then return to lowest gear once brake pedal is released. Again, in this scenario, at braking and mph decrease, Electromagnetic pads, at periphery of Drive Discs, take maximum distance OR change position to vertical, near vertical, or total obverse position to slow Drive Disc spin.

Power of acceleration (clock speed from 0-60 mph) would be determined by the synchronous spin dynamics of Drive Disc & Drive Shaft system. These can be set to surpass or, at least, equal the, now, prevailing horsepower and speed, the level of power of electromagnetic effect of pull/push of Electromagnetic pads against Drive Discs.

The apparatus is computer operated. The onboard computer is intrinsically designed to balance and effectuate to the drive train such initiations as accelerator depression, synchronizing rpm's/velocity of drive disks, brake pedal depressions, gear changes, gauging mph increases and decreases of vehicle, etc. The computer will be programmed for all such concerns involving precision operation of vehicle and safety situations at various speeds. In addition, the computer will have a function for storing vital data into a database. Such details as mph, brake pedal/accelerator depression, steering direction, impact, time of day, day of week, etc. In essence, a similar data storage & retrieval mechanism as featured with aircraft “black-box” technology would be utilized. This specified technology would allow the storage of data to remain in database for a prescribed period of time for retrieval. Both the Drive Shafts and Expansion Ring Gears are independently controlled by a hydraulic system FIG. 9:86A, 86B that positions the Drive Shafts and Gear components for acceleration, deceleration, neutral, reverse, etc. The hydraulic system is integral to and controlled by the onboard computer that receives its signals from operator in the vehicle.

The foregoing specifications constitute the main details for the concept of an automobile which will be designed to operate without using gas, electricity, or any solid or liquid fuel substance as a power source. It is to be expected that, through Research and Development, additional details, refinements, and/or revisions are to be made. Also, strategic placement and full range of capabilities of computer are yet to be defined.

NOTE: The electromagnetic spin of the Drive Discs are not consistent with any “perpetual-motion” concepts often presented to PTO. “Spin” and “movement” are under manually controlled conditions. The various speeds are no more perpetual than those of the traditional internal combustion engine under the control of a vehicle operator depressing the accelerator. Once accelerator is released, vehicle is designed to slow to a full stop. There is a “downshifting” to lower gears to the lowest speeds while the gear shift lever is in the “drive” position.

Conclusion, Ramifications, and Scope

Accordingly, the reader will see that the above-presented concept for a fuelless passenger automobile is an item that is in great need. In this regard, it should be ascertained that environmental pollution will be decidedly diminished if the present invention were to be generally put into use in the United States, as well as in other countries. Moreover, the concerns for reliance on other oil-producing countries will be assessed. All in all, the prospect of driving from one end of the country to the other without ever having to “fill up” for gasoline should impress anyone who is serious about saving money, preserving health, and doing something dramatically healthful for one's country. It's a question of, simply, doing the right thing.

1. I claim a means for propelling a vehicle, (passenger automobile) without benefit of any liquid or solid fuel comprising:
two longitudinally facing metallic discs of variable diameter, depending upon width of automobile, passing through the center of both layered disc is a vertical support which allows clockwise and counterclockwise spin of said discs, perpendicular peripheral width of surfaces of said discs will be magnetized for means of interaction with stationary electromagnets of same polarity of said peripheral surfaces, said interaction will cause said magnets to mutually repel each other causing said discs to spin in opposite directions, said discs will have, medially and laterally, interposed at opposite sides of said discs, lengths of two rods connecting with the facing sides of said discs, said rods will feature at their heads gears which will have means to fit into grooves for means of turning and supplying said turning power of said rods, (Drive Shafts-8) to connected rear and front wheels whereby vehicle will be caused to move in either a forward or rearward direction.
